(19) United States
(12) Patent Application Publication
(10) Pub. No.: US 2010/0020337 A1
(43) Pub. Date: Jan. 28, 2010

(54) APPARTUS FOR MARKING LUMBER POSITION

(76) Inventors: Alexandre Robichaud, Sherbrooke (CA); Luc Robichaud, Windsor (CA)

Correspondence Address: Arizona Parking Solution IP Holding 1;Attn.: Intellectual Property Department, 4198 Marcil, Montreal, QC, H4A 2Z6, CA

(21) Appl. No.: 12/499,315

(22) Filed: Jul. 8, 2009

Related U.S. Application Data
(60) Provisional application No. 61/083,194, filed on Jul. 24, 2008.

(51) Int. Cl. G01B 11/14

(52) U.S. Cl. 356/621

(57) ABSTRACT

An apparatus adapted to project a series of parallel light lines is provided, the apparatus comprising a body adapted to receive a plurality of light projecting devices, the plurality of light projecting devices being secured to the body and adapted to generate a series of parallel light lines to identify discrete parallel positions to facilitate the location of lumbers. A method of using same and a kit for assembling same are also provided.

### CROSS-REFERENCE

The present United States patent application relates to and claims priority from U.S. provisional patent application No. 61/083,194, filed Jul. 24, 2008 and entitled APPARATUS FOR MARKING LUMBER POSITION that is incorporated herein by reference.

### BACKGROUND OF THE INVENTION

1. Field of the Invention

This invention relates generally to an apparatus adapted to determine positions of lumbers. More precisely, the present invention relates to an apparatus having several spaced apart optical markers adapted to determine spaces between lumbers.

2. Description of the Related Art

Houses and other buildings are built with lumbers and other structural members. Lumbers are coming in various sizes like stringers and trusses that are adapted to fulfill different needs. Some lumbers are designed to build structures that support significant loads and others are intended to be used for the finishing of the building. Lumbers are preferably disposed at a constant distance therebetween in accordance with established standards.

The distance between trusses is typically 33.3 to 40.6 centimeters (12 or 16 inches) in North America. The distance between lumbers is of significant importance because, inter alia, dry wall panels, and other finishing materials, have a width of 122 centimeters (48 inches). In the case of a dry wall panel, one lumber supports one side of the panel, another lumber supports the other side of the panel in addition to 2 other lumbers disposed therebetween at every 40.6 centimeters (the distance being calculated between both lumber centers). In this case it takes 4 lumbers to secure the finishing material to the structure.

Construction workers need to measure the distances between lumbers to secure lumbers at the right distance therebetween. Measuring and marking every distance to locate correctly each lumber is a time consuming process. It is also possible that the worker marks incorrectly the position of the lumber and needs to measure a second time and even need to remove lumbers installed at the wrong place.

Therefore, an improved method and apparatus to measure the distance and locate the correct position of lumbers is desirable.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

One object of the present invention provides an apparatus parallely supporting light projecting means configured to draw a series of light lines at a distances therebetween to mark positions where lumbers should be installed on a structure.

An object of the present invention provides an apparatus having a plurality of light projecting means to define a series of parallel lines indicating the positions where lumbers should be located.

One other object of the present invention provides an apparatus adapted to be temporarily secured to a wall that accommodates a plurality of light projecting means at a distance therebetween to mark positions where lumbers and other trusses must be secured.

Another object of the present invention provides an apparatus comprising a plurality of light projecting means disposed at a constant interval therebetween and being foldable to ease the apparatus transport.

An object of the present invention provides an apparatus including a series of laser emitters disposed at constant intervals therebetween and providing a light line adapted to determine positions of lumbers to be installed on a wall structure.

One other object of the present invention provides an apparatus adapted to position a plurality of laser light projecting devices providing parallel linear marks indicating positions where lumbers should be positioned on a structure without having to measure the distance between the lumbers.

Another object of the present invention provides an apparatus for displaying a series of parallel light marks at a constant interval therebetween; the apparatus being adapted to be installed on walls, floor and ceiling.

An aspect of the present invention provides an apparatus adapted to project a series of parallel light lines, the apparatus comprising a body adapted to receive a plurality of light projecting devices, the plurality of light projecting devices being secured to the body and adapted to generate a series of parallel light lines to identify discrete parallel positions.

Another aspect of the present invention provides a method of drawing lines on a surface comprising providing a parallel light lines device; positioning the parallel light lines device; and powering a series of light lines projectors.

An aspect of the present invention provides a device for projecting a series of parallel light lines comprising an elongated body comprising a plurality of light line projectors positioned at a distance therebetween to project a series of simultaneous light lines on a surface or an object.

These and other advantages and features of the present invention will become apparent from the following description and the attached drawings.

### BRIEF DESCRIPTION OF THE DRAWINGS

FIG. 1 is a top plan view of a light emitter;

FIG. 2 is a side elevational view of the light emitter of FIG. 1 with a symmetrical light emission;

FIG. 3 is a side elevational view of the light emitter of FIG. 1 with a non-symmetrical light emission;

FIG. 4 is a schematic front elevational view and left side elevational view of an embodiment of the apparatus in accordance with the present invention;

FIG. 5 is a top elevational view of a room with two distinct apparatuses disposed on walls of a room to draw lines thereon;

FIG. 6 is a magnified perspective view of an embodiment of the present invention;

FIG. 7 is a perspective view of an embodiment of the present invention disposed next to a wall and a window; and

FIG. 8 is a perspective view of a foldable embodiment of the present invention.

### DESCRIPTION OF EMBODIMENT(S) OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details.

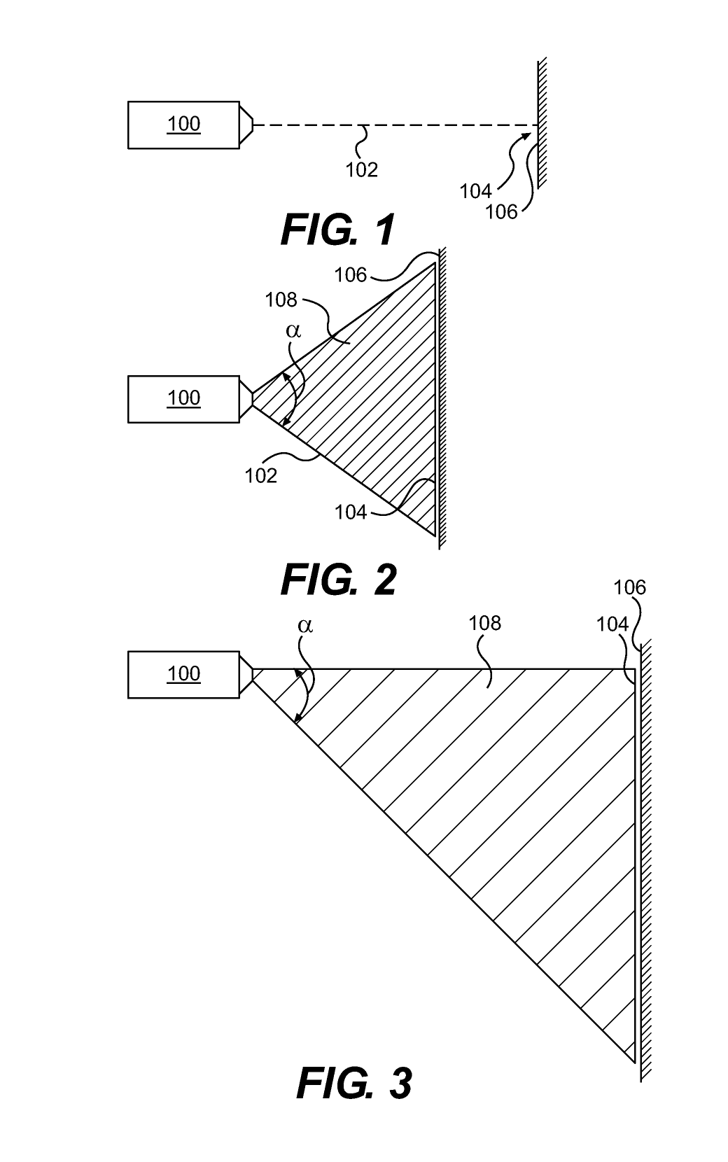

FIGS. 1 and 2 illustrate a light-projecting device 100 adapted to project light 102 providing a light mark 104 on the surface of an object 106. As best seen on FIG. 2, the projected light 102 is diffused with an angle α in a plane 108 so that the projected light results in a line 104 on the surface of the object 106. Similarly, FIG. 3 illustrates the light-projecting device 100 of FIG. 2 with a non-symmetrical light output angle α generating a light plane 108 that is offset on one side.

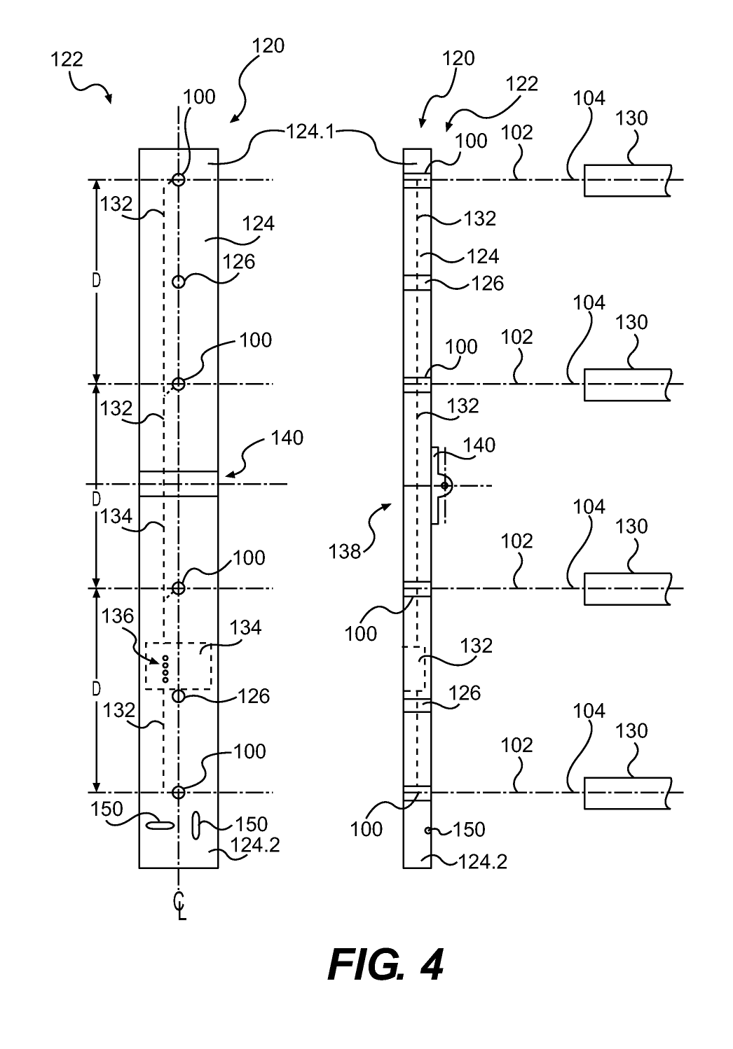

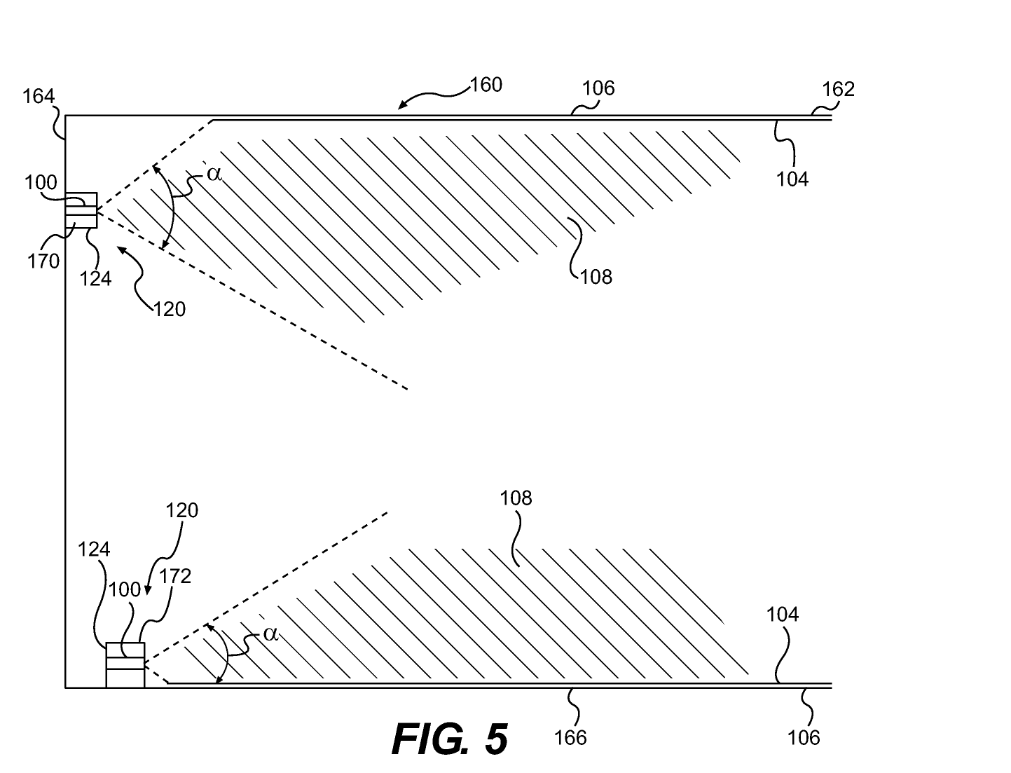

Referring now to FIG. 4 illustrating an apparatus 120 for generating a plurality of parallel light marks in accordance with the present invention. The apparatus 120 has a longitudinal shape 122 adapted to preferably be installed, secured or fastened to a wall, a ceiling or a floor. The body 124 of the apparatus 120 comprises a plurality of light projecting devices 100 disposed along at a constant distance D (although the distance therebetween can vary if desired) and aligned such that the projected light 102 is directed in the same direction.

The light-projecting device 100 of the present embodiment is a laser-projecting device projecting a fine plane of light that produces a line when it hits the surface of a flat object. Each light-projecting device 100 can be recessed in, glued on, press fit in the body 124 that can be made of wood, plastic or aluminum or other material suitable for this purpose and economical to produce. The light projecting devices 100 can alternatively be screwed in, maintained with a bracket or molded over by the material of the body 118 assuming the body is molded. The body 124 is made of a material that retains a linear shape, preferably light to ease transport and is easy to manipulate. The longitudinal dimension of the body 124 extends at least over the length needed to position all light projecting devices 100. The number of light projecting devices 100 varies as required to provide the desired number of light lines 104 adapted to identify where lumbers 130 should be located and secured.

As mentioned previously, the apparatus 120 has a body 124 made of a material suitable to receive a plurality of light projecting device 100 disposed at a distance “D” from one another. The distance “D” is generally of 406 millimeters (16 inches) in North America in accordance with standard practices of building construction. The distance between the light projecting devices 100 could be different therebetween if desired. In one embodiment, the position of the light projecting devices 100 is fixed. In a second embodiment, additional light projecting device receptacles 126 could be embedded in the body 124 and light-projecting devices 100 can be moved among receptacles 126 to be set apart proper distances therebetween. In a third embodiment, not illustrated, the body could be extendable between the light projecting devices 100 such that the distance therebetween be adjustable. In a fourth embodiment, not illustrated, a greater plurality of light projecting devices 100 are disposed in the body 124 and electrical selectors are discretely powering specific light projecting devices 100 disposed at desired intervals therebetween.

Each light projecting device 100 is electrically connected 132 to a battery pack 134 (or means to provide power) such that they can draw the energy needed to produce light lines 130. The battery pack 134 can illustratively be a simple set of 1.5V batteries coupled together to provide enough voltage to power the light projecting devices 100. The battery pack 134 can alternatively be plugged in to be recharged. A series of led indicators 136 are electrically connected to the battery pack 134 to show how much energy remains in the battery pack 134 and if it needs to be recharged.

The body 124 of an embodiment is foldable to ease its transport. The body 124 is separated in two portions 124.1, 124.2 (a different number of portions is not excluded from the scope of the present invention) and connected with a hinge 140. Once unfolded, the body 124 has the shape of an integral body 124. Conversely, once folded, the body 124 is more compact and easier to carry. The junction between the portions of the body 124.1, 124.2 includes releasable electrical connectors 138 adapted to make the electrical circuit connection therebetween. An extendable wire could alternatively be used to bridge the electrical circuit on the portions of the body 124.1, 124.2 and maintain the integrity of the electrical circuit 122 when the body 118 is folded and not folded.

The light-projecting device 100 generates light lines 104 that are used to indicate the position of lumbers to be assembled or already assembled. In order to make sure the apparatus 120 is well aligned, to avoid drawing lines 130 that are not in the desired direction, vertical and horizontal levels 150 are provided on the body 118.

Turning now to FIG. 5 where are illustrated two apparatuses 120 seen from above in a room 160 bordered with three (3) walls 162, 164, 166. The first apparatus 170 is vertically installed on a wall 164 while projecting horizontal light lines 108 on a perpendicular wall 162. The second apparatus 172 is also vertically installed on a wall 166 while projecting light lines 108 on the same wall 166. Another alternative, not shown on FIG. 5, is to project light lines 104 on an opposite wall, embodiment that is also within the scope of the present invention.

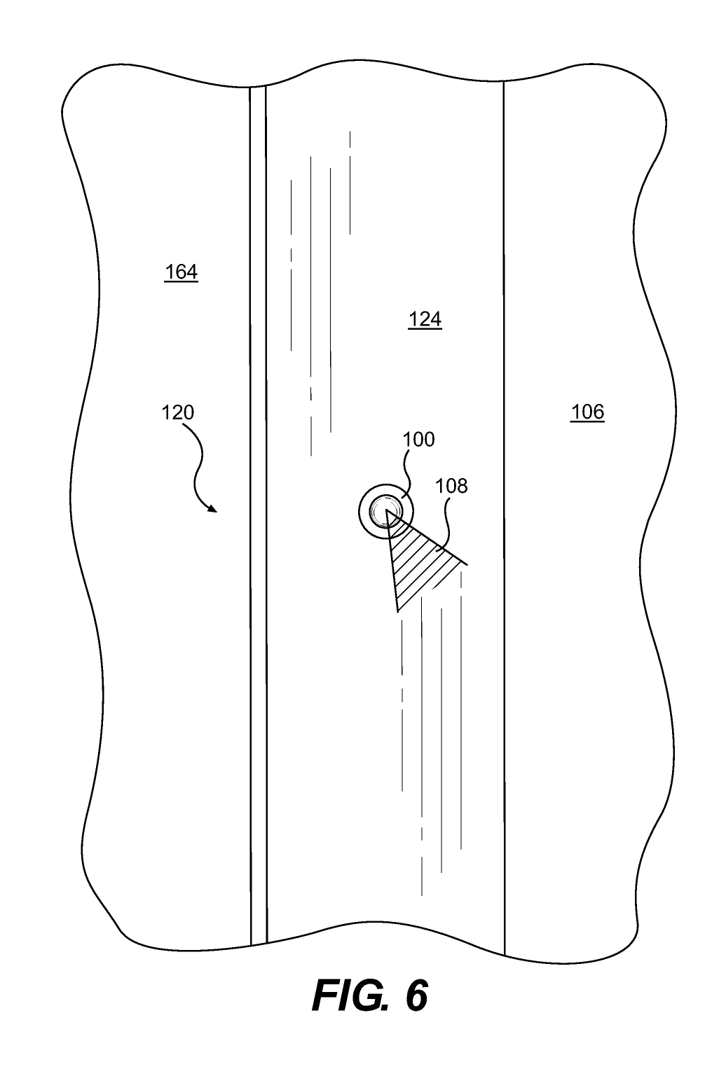

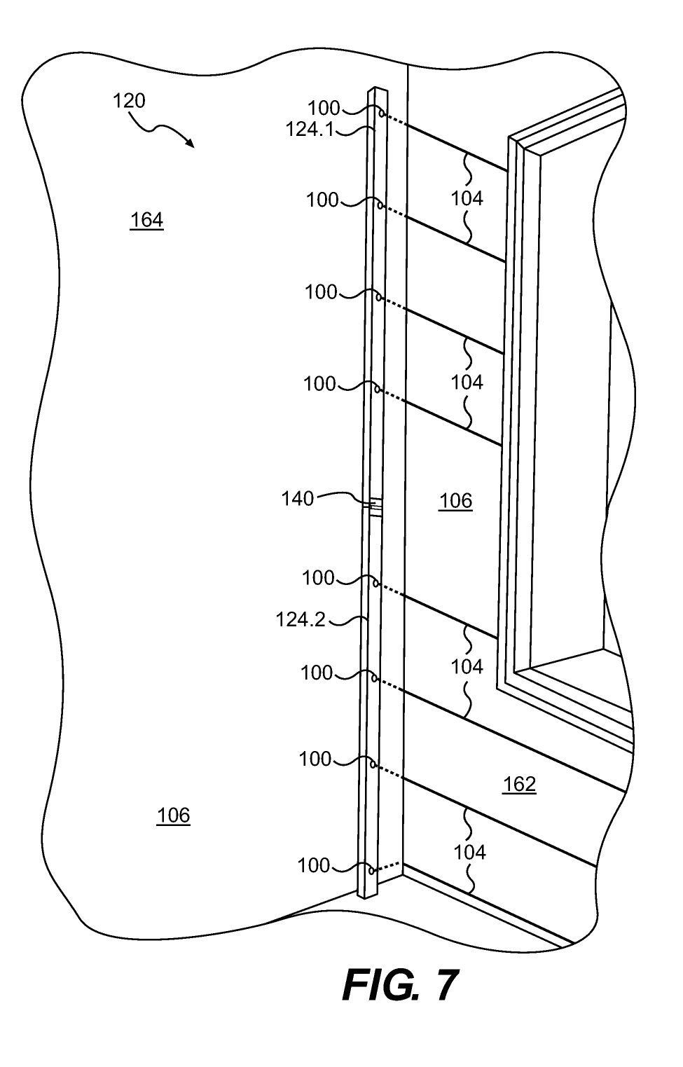

FIG. 6 is a magnified illustration of one of the apparatuses 120 of FIG. 5 as positioned on the wall 164. A single light-projecting device 100 is depicted producing a plane of light 108 that will produce a light line 104 on an adjacent wall. FIG. 7 is another illustration of an apparatus 120 disposed on the wall 164 of the room of FIG. 5. It is easier to see the series of light lines 104 parallely disposed form one another.

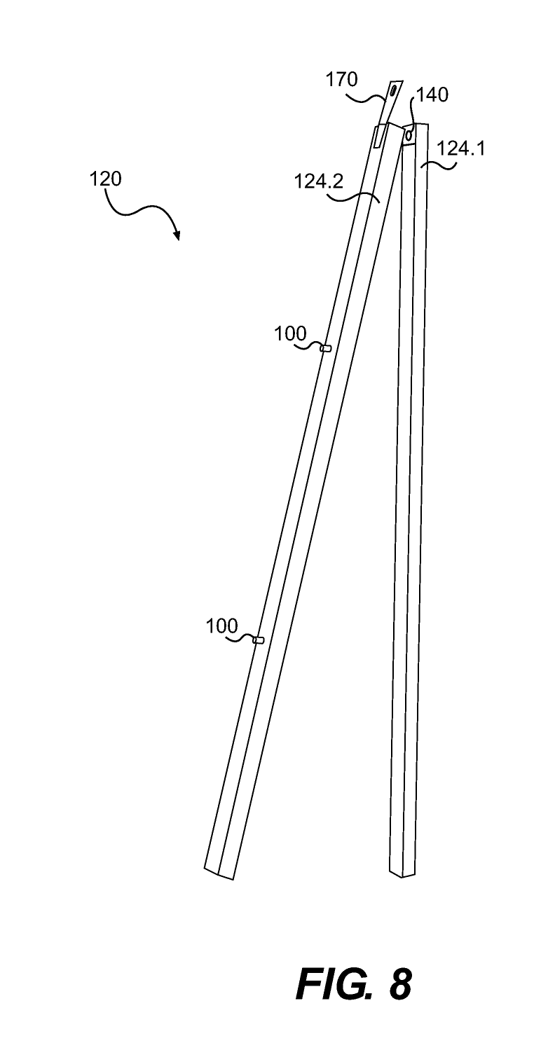

FIG. 8 depicts another exemplary embodiment illustrating a body 124 comprising two abutted body portions 124.1 and 124.2. Both body portions 124.1, 124.2 are pivotally secured thereto with a hinge 140 mechanism. A locking mechanism 170 is provided to secure both body portions 124.1, 124.2 together in an extended configuration. Another locking mechanism (not illustrated) is provided to secure both body portions 124.1 and 124.2 in a folded configuration. Additional body portions 124 could be added to reduce the length of each body portions 124 and facilitate handling of the folded device 120.

The present invention can be sold as a kit with separated body portions 124 and a plurality of light projecting devices 100. The body portions 124 are configured to be secured together and also provide a plurality of light projecting device receptacles 126 thereon. When assembled, the light projecting devices 100 are secured to selected light projecting device receptacles 126 at a proper distance therebetween.

The description and the drawings that are presented above are meant to be illustrative of the present invention. They are not meant to be limiting of the scope of the present invention. Modifications to the embodiments described may be made without departing from the present invention, the scope of which is defined by the following claims:

What is claimed is:

1. An apparatus adapted to project a series of parallel light lines, the apparatus comprising a body adapted to receive a plurality of light projecting devices, the plurality of light projecting devices being secured to the body and adapted to generate a series of parallel light lines to identify discrete parallel positions

2. The apparatus of claim 1, wherein the plurality of parallel light lines provides positioning marks for installation of lumbers.

3. The apparatus of claim 1, wherein at least some of the light projecting devices are laser projectors.

4. The apparatus of claim 1, wherein the body has a substantially longitudinal shape adapted to receive a plurality of light projecting devices thereon.

5. The apparatus of claim 1, wherein at least two light projecting devices are spaced apart by about 406 millimetres (16 inches).

6. The apparatus of claim 1, wherein the body is adapted to receive four light projecting devices therein.

7. The apparatus of claim 1, wherein the body is foldable.

8. The apparatus of claim 1, wherein the body is extendable to set a distance between two light projecting devices.

9. The apparatus of claim 1, wherein the body is adapted to contain a power pack configured to power the light projecting devices.

10. The apparatus of claim 1, wherein the body comprises a level thereon.

11. A method of drawing lines on a surface comprising:
providing a parallel light lines device;
positioning the parallel light lines device; and
powering a series of light lines projectors.

12. The method of claim 11, comprising unfolding the parallel light lines device.

13. The method of claim 12, comprising altering an angle of diffusion of at least one light line projector.

14. A device for projecting a series of parallel light lines comprising an elongated body comprising a plurality of light line projectors positioned at a distance therebetween to project a series of simultaneous light lines on a surface or an object.
